(19) United States
(12) Patent Application Publication
(10) Pub. No.: US 2008/0245177 A1
(43) Pub. Date: Oct. 9, 2008

(54) Bicycle transmission mechanism

(76) Inventor: Bing-He Feng, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/155,779

(22) Filed: Jun. 10, 2008

Related U.S. Application Data
(63) Continuation-in-part of application No. 10/823,747, filed on Apr. 14, 2004.

(51) Int. Cl. B62M 25/04

(52) U.S. Cl. 74/502.2

(57) ABSTRACT

A bicycle transmission mechanism including: a fixed housing having an annular cavity; a ratchet member attached to a wall of the annular cavity of the fixed housing; a locking member slidably disposed in the annular cavity of the fixed housing, the locking member being formed with a cord hole, a cord head of a steel cord being fitted in the cord hole, a cord body of the steel cord extending from the cord head out of the cord hole, the cord head and the cord body containing an angle, whereby the cord head provides a resilient force which makes a first end of the locking member always tend to deflect toward the ratchet member and engage therewith so as to one-way detent the locking member; and a rotary member having a projecting linking section for rotationally driving the locking member to wind/unwind the steel cord.

### CROSS-REFERENCE TO RELATED APPLICATION

This application is a Continuation-in-Part Application of U.S. patent application Ser. No. 10/823,747, entitled “Bicycle Transmission Control Device”, filed on 14 Apr. 2004, now pending.

### BACKGROUND OF THE INVENTION

1. Field of the Invention

The present invention is related to a bicycle transmission mechanism including a locking member formed with a cord hole. A cord head of a steel cord is fitted in the cord hole. The cord head and the cord body of the steel cord contain the angle to provide a resilient force, which makes the locking member always tend to deflect and engage with a ratchet member to one-way detent the locking member.

2. Description of the Prior Art

U.S. Pat. No. 6,216,553 discloses a selector for a bicycle gear mechanism. As shown in FIGS. 1 and 2 of this patent, the selector includes a housing 1 and a guide tube 2 fixedly mounted on a handlebar of a bicycle. A spring 6 having a hook portion 7 is inserted in the housing 1. The selector further includes a rotary bushing 10 rotatably fitted on the guide tube 2. The rotary bushing 10 has a rotary element 11. Multiple shift detents 12 are disposed on inner circumference of the rotary element 11 for engaging with the hook portion 7 of the spring 6. A correction cam 13 is disposed on outer circumference of the rotary bushing 10. A pivoting lever 15 is pivotally mounted in the housing 1. A free end of the pivoting lever 15 has a pivoting cam 17. The spring 6 always exerts a force onto the pivoting cam 17 to deflect toward the rotary bushing 10, whereby the pivoting cam 17 is engaged with the correction cam 13 of the rotary bushing 10. A pivoting lever 15 has a first cable deflection radius 18. The selector further includes a control cable 16. A head end of the control cable 16 is fixed on the rotary bushing 10. The control cable 16 passes through the first cable deflection radius 18 of the pivoting lever 15 and goes out of the housing 1 to connect with the gear mechanism of the bicycle. By means of the engagement between the pivoting cam 17 and the correction cam 13 and the engagement between the hook portion 7 of the spring 6 and the shift detents 12 of the rotary bushing 10, the rotary bushing 10 is located and detented. Accordingly, the control cable 16 can be stably wound or unwound.

However, the above selector still has some defects as follows:

1. The spring 6 enables a user to perceive the engagement when rotating the rotary bushing 10. In general, the spring 6 is made of steel plate. After a period of use, the spring 6 is likely to elastically fail or break. This will shorten using life of the product.

2. After a period of use, the spring 6 is likely to elastically fail. At this time, the elasticity of the spring 6 is deteriorated. Under such circumstance, the rotary bushing 10 can be hardly accurately located. As a result, a user will be unable to accurately operate the selector to shift the gear.

3. When the rotary bushing 10 rotates, the hook portion 7 of the spring 6 is compressed to disengage from one shift detent 12 and resiliently engage with next shift detent 12. Accordingly, it is laborious to rotate the rotary bushing 10.

4. The rotary bushing 10 is equipped with the shift detents 12 and the correction cam 13 for cooperating with the spring 6. Such structure is complicated and hard to assemble. Therefore, the manufacturing cost is increased.

5. The control cable 16 longitudinally passes through the pivoting lever 15 to be latched with the rotary bushing 10. When the rotary bushing 10 is clockwise rotated to unwind the control cable 16 as shown in FIG. 2 of the aforesaid patent, great frictional resistance exists between the control cable 16 and the pivoting lever 15. In addition, in the case that the pulling force of the transmission chaining mechanism connected with the tail end of the control cable 16 is less than the frictional resistance, it will be impossible to unwind the control cable 16 from the rotary bushing 10 to shift the gear. Similarly, when winding the control cable 16, the frictional resistance between the control cable 16 and the pivoting lever 15 must be overcome. Therefore, it is quite laborious and inconvenient to rotate the rotary bushing 10 for winding the control cable 16.

6. Both when winding and unwinding the control cable 16, the pivoting cam 17, 35 or 44 of the free end of the pivoting lever 15 resiliently abuts against the correction cam 13, 36 or 42 of the rotary bushing 10. Therefore, after a period of use, these components are very likely to wear. Under such circumstance, they will be unable to snugly engage with each other. This shortens using life of the product.

### SUMMARY OF THE INVENTION

It is therefore a primary object of the present invention to provide a bicycle transmission mechanism including: a fixed housing having a central sleeve section for fixedly fitting the fixed housing on a handlebar of a bicycle, one side of the fixed housing being recessed to form an annular cavity around the sleeve section; a ratchet member having multiple ratchets, the ratchet member being attached to a wall of the annular cavity of the fixed housing; a locking member slidably disposed in the annular cavity of the fixed housing between the ratchet member and the sleeve section of the fixed housing, the locking member being formed with a cord hole, a cord head of a steel cord being fitted in the cord hole, a cord body of the steel cord extending from the cord head out of the cord hole, the cord head being bent from the cord body so that the cord head and the cord body contain an angle, whereby the cord head provides a resilient force which makes a pawl of a first end of the locking member always tend to deflect toward the ratchets of the ratchet member and engage therewith so as to one-way detent the locking member, the locking member being formed with a dent; and a rotary member rotatably fitted on the sleeve section of the fixed housing, the rotary member having a projecting linking section, the linking section being positioned in the dent of the locking member for driving the locking member to rotate about the sleeve section of the fixed housing for winding/unwinding the steel cord.

The present invention can be best understood through the following description and accompanying drawings wherein:

### BRIEF DESCRIPTION OF THE DRAWINGS

FIG. 1 is a perspective exploded view of the present invention;

FIG. 2 is a perspective assembled view of the present invention;

FIG. 3 is a partially sectional view taken along line 3-3 of FIG. 2;

FIG. 4 is a partially sectional view according to FIG. 3, in which the rotary member is rotated in direction R1;

FIG. 5 is a partially sectional view according to FIG. 4, in which the rotary member is further rotated in direction R1 to engage the locking member with next ratchet; and

FIG. 6 is a partially sectional view according to FIG. 5, in which the rotary member is rotated in direction R2 to disengage the locking member from the ratchet member.

### DETAILED DESCRIPTION OF THE PREFERRED EMBODIMENTS

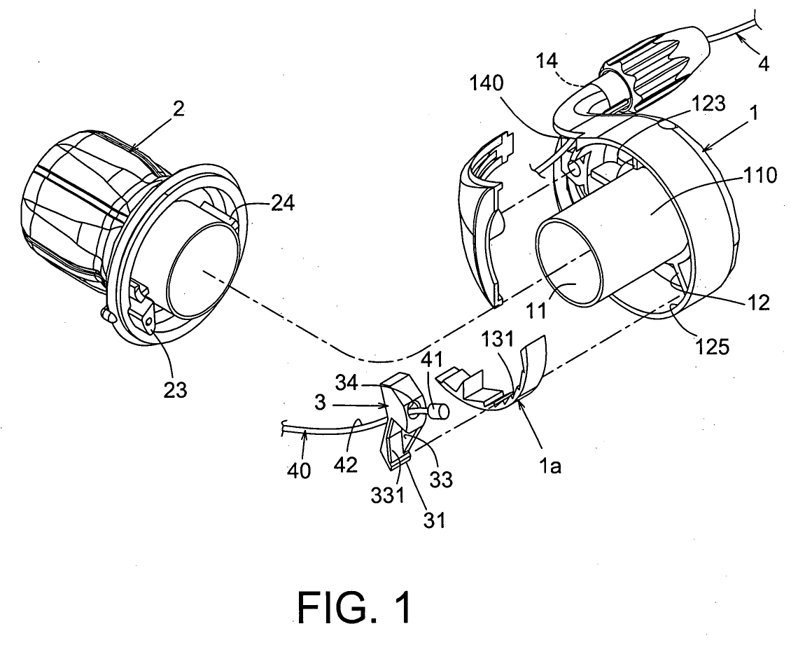

Please refer to FIGS. 1 to 6. The bicycle transmission mechanism of the present invention includes a fixed housing 1, a ratchet member 1a, a locking member 3 and a rotary member 2. The fixed housing 1 has a central sleeve section 110 for fixedly fitting the fixed housing 1 on a handlebar of a bicycle. One side of the fixed housing 1 is recessed to form an annular cavity 12 around the sleeve section 110. The ratchet member 1a has multiple ratchets 131. The ratchet member 1a is attached to a wall of the annular cavity 12 of the fixed housing 1. The locking member 3 is slidably disposed in the annular cavity 12 of the fixed housing 1 between the ratchet member 1a and the sleeve section 110 of the fixed housing 1. The locking member 3 is formed with a cord hole 34. A cord head 41 of a steel cord 4 is fitted in the cord hole 34. A cord body 42 of the steel cord 4 extends from the cord head 41 out of the cord hole 34. The cord head 41 is bent from the cord body 42, whereby the cord head 41 and the cord body 42 contain an angle A. Accordingly, the cord head 41 provides a resilient force F which makes a pawl 31 of a first end of the locking member 3 always tend to deflect toward the ratchets 131 of the ratchet member 1a and engage therewith so as to one-way detent the locking member 3. In addition, the locking member 3 is formed with a dent 33. The rotary member 2 is rotatably fitted on the sleeve section 110 of the fixed housing 1. The rotary member 2 has a projecting linking section 23. The linking section 23 is positioned in the dent 33 of the locking member 3 for driving the locking member 3 to rotate about the sleeve section 110 of the fixed housing 1 for winding/unwinding the steel cord 4.

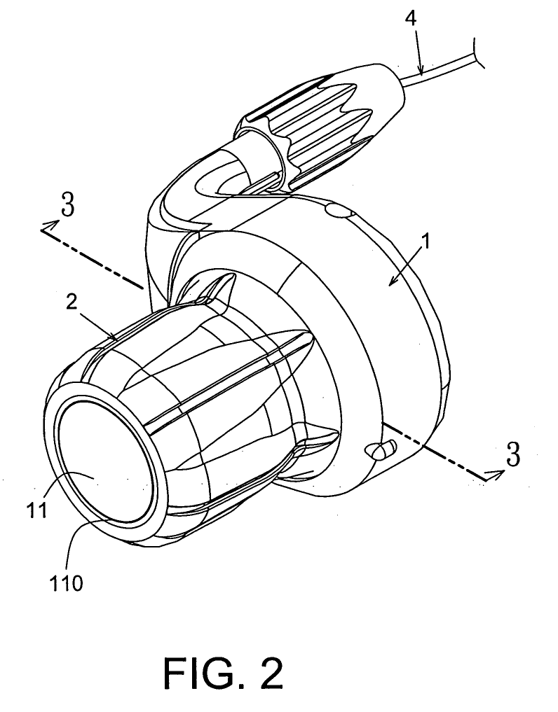

Please refer to FIGS. 1 and 2. The sleeve section 110 of the fixed housing 1 is formed with a central axial fixing through hole 11 for fitting the fixed housing 1 on the handlebar (not shown) of the bicycle. The annular cavity 12 is formed around the sleeve section 110. A first stopper section 123 and a second stopper section 124 are disposed in the annular cavity 12 for stopping a stop key 24 of the rotary member 2. Therefore, the rotational angle of the rotary member 2 is limited within a certain range. A chucking slot 125 is disposed on the wall of the annular cavity 12, in which the ratchet member 1a is fixedly chucked. A cord hole 14 is formed on the fixed housing 1. The steel cord 4 extends through the cord hole 14 out of the fixed housing 1. A guide channel 140 is formed on the fixed housing 1 and adjacent to an inner end of the cord hole 14. The steel cord 4 is accommodated in the guide channel 140 and guided to stably slide in the fixed housing 1.

Referring to FIG. 1, the ratchet member 1a of the present invention is an independent component separable from the fixed housing 1. Alternatively, the ratchet member 1a can be integrally connected with the fixed housing 1 as a one-piece component.

The dent 33 of the locking member 3 has a bottom face which is a linking slope 331 positioned at the first end of the locking member 3. When the linking section 23 of the rotary member 2 is rotated toward the first end of the locking member 3 in a direction R2, the linking section 23 pushes the linking slope 331 and drives the pawl 31 of the first end of the locking member 3 away from the ratchet member 1a. At this time, the pawl 31 is disengaged from the ratchet member 1a. Under such circumstance, the rotary member 2 can be rotated in direction R2 to unwind the steel cord 4.

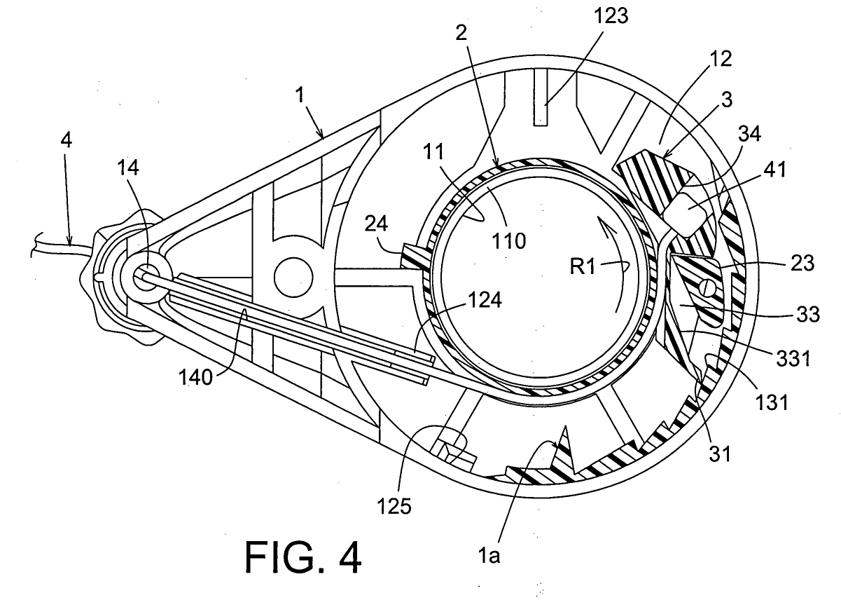

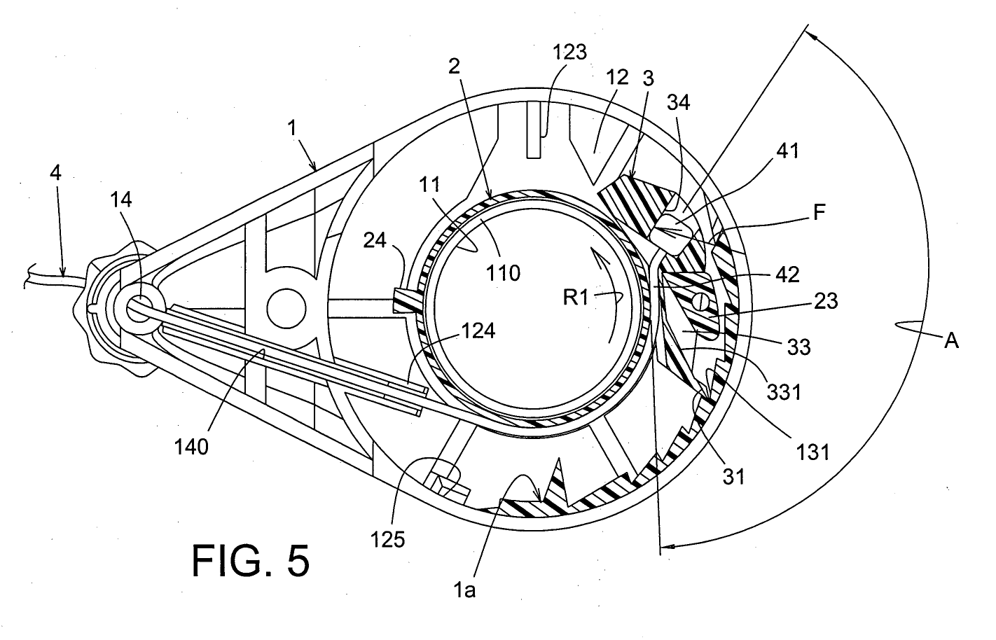

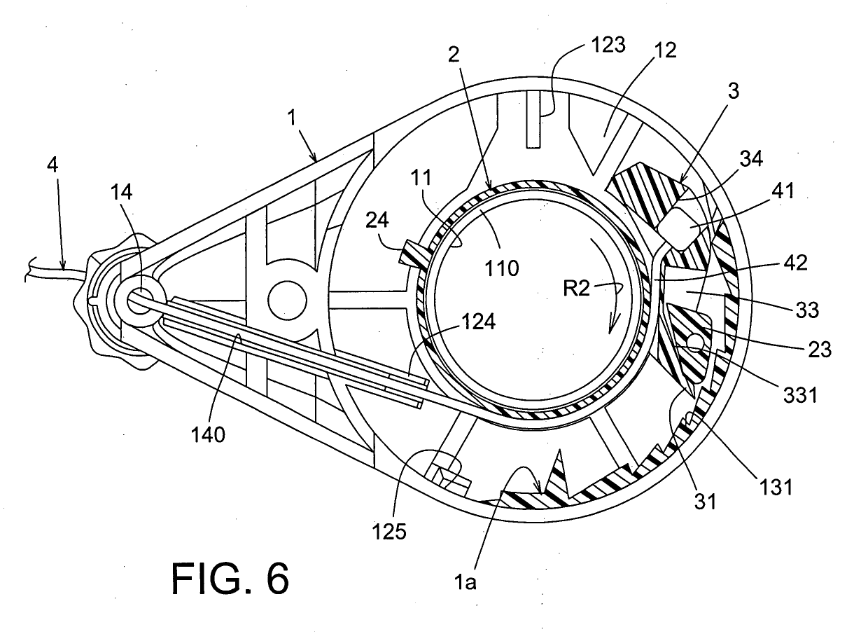

Please refer to FIGS. 1, 2 and 3. When a user rotates the rotary member 2 in a direction R1, the linking section 23 of the rotary member 2 drives the locking member 3 to rotate. At this time, the pawl 31 of the first end of the locking member 3 is forced back by the ratchet slops of the ratchet member 1a as shown in FIG. 4. Therefore, the rotary member 2 can be rotated without obstacle. When the user further rotates the rotary member 2 in direction R1, the pawl 31 of the first end of the locking member 3 is engaged with a next ratchet 131. Then the user stops rotating the rotary member 2 as shown in FIG. 5. At this time, the cord head 41 of the steel cord 4 exerts a resilient force F onto the locking member 3, whereby the pawl 31 of the first end of the locking member 3 is moved toward the ratchet member 1a to engage with the corresponding ratchet 131 so as to detent the rotary member 2. Under such circumstance, the rotary member 2 is prevented from being rotated in reverse direction. Accordingly, the steel cord 4 can be wound. When it is desired to unwind the steel cord 4, as shown in FIG. 6, the user can rotate the rotary member 2 in direction R2. At this time, the linking section 23 of the rotary member 2 pushes the linking slope 331 and drives the pawl 31 of the first end of the locking member 3 away from the ratchet member 1a, whereby the pawl 31 is disengaged from the ratchet member 1a. Under such circumstance, the rotary member 2 can be rotated in direction R2 without resistance to unwind the steel cord 4.

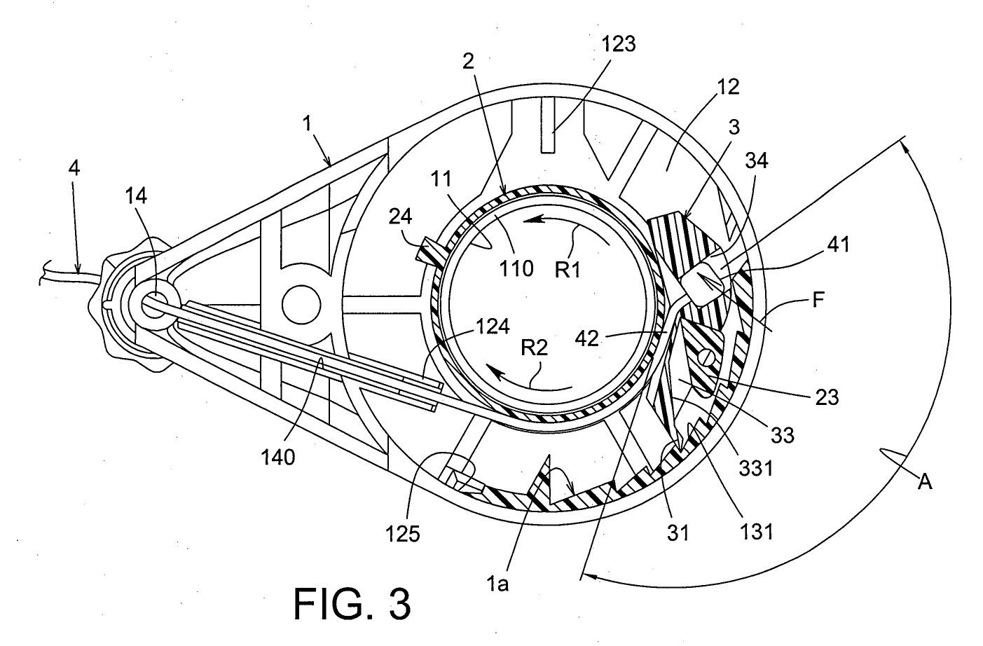

Referring to FIG. 3, the cord head 41 is resiliently bent from the cord body 42, whereby the cord head 41 and the cord body 42 contain the angle A. Accordingly, the cord head 41 provides the resilient force F which makes the pawl 31 of a first end of the locking member 3 always tend to deflect to the ratchet member 1a. The locking member 3 is constantly directly tensioned by the steel cord 4, while the steel cord 4 is constantly tensioned by the remote bicycle gear mechanism. Therefore, the pawl 31 of the locking member 3 will automatically engage with the corresponding ratchet 131 of the ratchet member 1a to locate the rotary member 2. When winding the steel cord 4, the pawl 31 of the locking member 3 will engage with the ratchets 131 of the ratchet member 1a one by one to emit perceivable click sounds. Therefore, the conventional perceptional spring is omissible. When unwinding the steel cord 4, the linking section 23 of the rotary member 2 pushes the linking slope 331 and drives the pawl 31 of the first end of the locking member 3 away from the ratchet member 1a, whereby the pawl 31 is fully disengaged from the ratchet member 1a. Therefore, in the rotation operation, the rotary member is rotated without any resistance. Moreover, the other end of the steel cord 4 is constantly tensioned by the remote bicycle gear mechanism so that the steel cord 4 can be unwound with less strength. Furthermore, the wear of the pawl 31 can be minified to prolong using life of the product. The bicycle transmission mechanism of the present invention has simplified structure and can be more easily and fast assembled. In operation, a user is free from the resilient force of the conventional perceptional spring and the frictional resistance between the control cable and the pivoting lever. Therefore, the present invention can be operated with much less strength.

The above embodiments are only used to illustrate the present invention, not intended to limit the scope thereof. Many modifications of the above embodiments can be made without departing from the spirit of the present invention.

What is claimed is:

1. A bicycle transmission mechanism comprising:
a fixed housing having a central sleeve section for fixedly fitting the fixed housing on a handlebar of a bicycle, one side of the fixed housing being recessed to form an annular cavity around the sleeve section;
a ratchet member having multiple ratchets, the ratchet member being attached to a wall of the annular cavity of the fixed housing;
a locking member slidably disposed in the annular cavity of the fixed housing between the ratchet member and the sleeve section of the fixed housing, the locking member being formed with a cord hole, a cord head of a steel cord being fitted in the cord hole, a cord body of the steel cord extending from the cord head out of the cord hole, the cord head being bent from the cord body so that the cord head and the cord body contain an angle, whereby the cord head provides a resilient force which makes a first end of the locking member always tend to deflect toward the ratchets of the ratchet member and engage therewith so as to one-way detent the locking member, the locking member being formed with a dent; and
a rotary member rotatably fitted on the sleeve section of the fixed housing, the rotary member having a projecting linking section, the linking section being positioned in the dent of the locking member for driving the locking member to rotate about the sleeve section of the fixed housing for winding/unwinding the steel cord.

2. The bicycle transmission mechanism as claimed in claim 1, wherein the sleeve section of the fixed housing is formed with a central axial fixing through hole for fitting the fixed housing on the handlebar of the bicycle, the annular cavity being formed around the sleeve section, a first stopper section and a second stopper section being disposed in the annular cavity for stopping a stop key of the rotary member, whereby rotational angle of the rotary member is limited within a certain range, a chucking slot being disposed on the wall of the annular cavity, in which the ratchet member is fixedly chucked, a cord hole being formed on the fixed housing, the steel cord extending through the cord hole out of the fixed housing, a guide channel being formed on the fixed housing and adjacent to an inner end of the cord hole, the steel cord being accommodated in the guide channel and guided to stably slide in the fixed housing.

3. The bicycle transmission mechanism as claimed in claim 1, wherein the ratchet member is integrally formed on the fixed housing.

4. The bicycle transmission mechanism as claimed in claim 1, wherein the dent of the locking member has a bottom face which is a linking slope positioned at the first end of the locking member, whereby when the linking section of the rotary member is rotated toward the first end of the locking member, the linking section pushes the linking slope and drives the first end of the locking member away from the ratchet member to disengage from the ratchet member.
